(19) United States
(12) Patent Application Publication
(10) Pub. No.: US 2009/0053564 A1
(43) Pub. Date: Feb. 26, 2009

(54) METHOD AND SYSTEM FOR OPERATING FUEL CELL STACKS TO REDUCE NON-STEADY STATE CONDITIONS DURING LOAD TRANSIENTS

(76) Inventor: Richard G. Fellows, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/027,475

(22) Filed: Feb. 7, 2008

Related U.S. Application Data
(60) Provisional application No. 60/999,767, filed on Jun. 28, 2007.

(51) Int. Cl. H01M 8/04

(52) U.S. Cl. 429/13; 429/24

(57) ABSTRACT

Methods and systems for reducing irregularities in temperature distribution in the operation of a fuel cell stack during a load transient based on the actual stack outlet temperature. In representative embodiments, the coolant flow rate and/or the oxidant stoichiometry is adjusted during a load transient based on a determined value for the same in view on the actual stack outlet temperature. As a result, the fuel cell reaches steady state conditions more quickly, thus reducing periods of non-steady state fuel cell operation.

### CROSS-REFERENCE TO RELATED APPLICATION

This application claims the benefit under 35 U.S.C. § 119(e) of U.S. Provisional Patent Application No. 60/999,767 filed Jun. 28, 2007, which application is incorporated herein by reference in its entirety.

### BACKGROUND

1. Technical Field

The present invention relates to fuel cell stacks, and more specifically, to methods of operating fuel cell stacks during load transients to reduce non-steady state operation conditions.

2. Description of the Related Art

Fuel cells, such as proton exchange membrane (PEM) fuel cells, are currently being developed for a variety of applications, such as automotive, backup power, and stationary applications. For fuel cells that utilize a polymer electrolyte membrane, the preferred operating temperature range for PEM fuel cells is typically between 30° C. to 120° C., for example, between 50° C. and 80° C.

During normal operation, fuel and oxidant fluids, for example, hydrogen-containing fuel and air, respectively, are supplied to the fuel cell anode and cathode, respectively. Fuel is electrochemically oxidized on the anode side, resulting in the generation of protons, electrons, and possibly other species depending on the fuel employed. The protons are conducted from the reaction sites at which they are generated and through the membrane to electrochemically react with the oxidant on the cathode side. The electrons travel through an external circuit providing useable power and then react with the protons and oxidant on the cathode side to generate water reaction product. For the fuel cell stack to operate efficiently, the fluids are typically supplied at predetermined conditions, for example, humidities, temperatures, pressures, flow volumes and/or flow rates, so that the fluids are at the desired conditions for the required power output at steady state conditions. Typically, a coolant, such as a liquid coolant, is circulated during operation to regulate the temperature and temperature distribution of the stack, as well as to prevent it from overheating.

During a load transient, the power drawn from the fuel cell stack is increased or decreased as requested by the user, and the operating conditions of the fuel cell stack and the load (or current) are changed accordingly. However, the thermal mass of the fuel cell stack is typically large, so temperatures are slow to respond to transient conditions. Thus, if the conditions of the reactant gas streams and coolant streams are changed immediately upon a change in load, the fuel cells may experience excessive drying or flooding initially upon the load change if the stack has not yet reached the desired temperature distribution for the target load. Such non-steady state conditions may result in improper or insufficient membrane hydration, which will have a negative effect on fuel cell performance and durability. As a result, in some methods, a time lag is implemented when changing the operating parameters of the fuel cell stack to avoid excessive drying or flooding from occurring within the fuel cells during load transients. However, this approach is difficult to implement as it requires extensive fine-tuning and may not account for component variability over the operating life of the fuel cell stack, such as fuel cell component degradation, which may change the desired lag time.

In one method, as described in U.S. Patent Application No. 2006/0263654, a model is used to predict the relative humidity profile that will occur in response to changes to one or more of the operating characteristics of the fuel cell. However, measuring or determining the relative humidity of the cathode reactant flowing into the fuel cells, at times, may be impossible or difficult to ascertain. Therefore, in one method, a measure of the high frequency resistance can be used to approximate the relative humidity of the cathode reactant flowing into the fuel cell stack. Specifically, empirical data of the performance of the stack or a comparable stack can be recorded for various operating conditions, and the relative humidity of the cathode reactant flowing into the fuel cell stack can be ascertained based upon the measure of the high frequency resistances and the values of the other operating parameters of the fuel cell stack that influence the high frequency resistance. However, such a method is complex and difficult to implement, and may be inaccurate over the lifetime of the fuel cell stack due to fuel cell degradation, which may affect the high frequency resistances of the fuel cells.

Accordingly, there remains a need in the art to provide simpler methods of controlling the operating parameters of the fuel cell stack during load transients. This invention addresses this problem and provides further related advantages.

### BRIEF SUMMARY

In one embodiment, the invention relates to a method of operating a fuel cell stack having at least one fuel cell during a load transient, the method comprising providing fuel and oxidant to the fuel cell stack at a fuel stoichiometry and an oxidant stoichiometry; circulating a coolant through the fuel cell stack at a coolant inlet temperature and a coolant flow rate; determining a stack outlet temperature; determining a target coolant flow rate based solely on the determined stack outlet temperature; and adjusting the coolant flow rate based on the determined target coolant flow rate.

In another embodiment, the invention relates to a method of operating a fuel cell stack having at least one fuel cell during a load transient, the method comprising providing fuel and oxidant to the fuel cell stack at a fuel stoichiometry and an oxidant stoichiometry, respectively; circulating a coolant through the fuel cell stack at a coolant flow rate; determining a stack outlet temperature; determining a target oxidant stoichiometry based solely on the determined stack outlet temperature; and adjusting the oxidant stoichiometry based on the determined target oxidant stiochiometry.

These and other aspects of the invention will be evident in view of the following detailed description.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been described in detail to avoid unnecessarily obscuring descriptions of the embodiments of the invention.

Unless the context requires otherwise, throughout the specification and claims which follow, the word “comprise” and variations thereof, such as “comprises” and “comprising” are to be construed in an open, inclusive sense, that is, as “including but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present context, “relative humidity” or “RH” means the ratio of the partial pressure of water vapour in the fuel or air stream, compared to the partial pressure of water that the fuel or air stream can hold if it was fully saturated.

As used herein, “load” means current (expressed in amperes) or current density (expressed in amperes/unit surface area of the fuel cell).

For normal steady state operation, the operating conditions of the fuel cell stack are usually predetermined for particular loads. These operating conditions include, but are not limited to, the fuel and oxidant supply pressures, temperatures, and stoichiometries; coolant inlet temperature; coolant outlet temperature; and coolant flow rate. For example, when operating at a low load, water production is low and a small amount of heat is generated. In this case, the desired (hereinafter used interchangeably with “target”) coolant temperature differential (i.e., temperature difference between the coolant inlet and coolant outlet, or simply the “coolant dT”) and the desired coolant flow rate are typically low at steady state to prevent overly drying the fuel cells. Conversely, when operating at a high load, water production is high and a large amount of heat is generated. At steady state, the desired coolant dT is typically high to remove the product water and the desired coolant flow rate is typically high to prevent the stack from overheating.

During a load transient, the load is changed from a first load to a second load. Since the first and second loads are different, the steady state operating conditions of the fuel cell stack are usually different as well. However, the conditions of the fuel cells, in particular, the temperature and temperature distribution of the fuel cells, are typically not at steady state immediately after a change in load due to the slow thermal response of the stack. For example, immediately upon a down transient from a high load to a low load, the fuel cell stack may experience about an 8 to 10° C. temperature difference between the actual stack outlet temperature and the target stack outlet temperature at the second load that would be observed when fuel cell reaches steady state. In some cases, it may take upwards of a minute to reach steady state conditions, which is typically too long for most load cycles in automotive applications, thus resulting in extended periods of non-steady state operation. This situation may be further exacerbated if the fuel cell stack is operating at a RH of less than 100%, for example, less than 90%, because the fuel cell membranes are more sensitive to temperatures at sub-saturated RH conditions.

Accordingly, the present method is directed to reducing irregularities in temperature distribution during load transients. In one embodiment, the coolant flow rate is varied based on the actual fuel cell stack outlet temperature (instead of the load as in prior art methods). In this embodiment, the coolant flow rate increases with increasing stack outlet temperature. For instance, on a down-transient, the load is decreased to a lower target load. As mentioned before, the target coolant dT, target stack outlet temperature and target coolant flow rate at the lower target load are lower due to decreased heat generation. However, upon the load decrease, the actual coolant dT and actual stack outlet temperature do not decrease immediately due to the thermal mass of the stack. Since, in the practice of this method, the coolant flow rate varies with the actual stack outlet temperature, this results in a higher coolant flow rate than would be required when the fuel cell was at steady state at the lower target load. Thus, the actual coolant dT and actual coolant outlet temperature will decrease faster (because the stack will cool down faster since the coolant flow rate is high) to the target coolant dT and target stack outlet temperature for the lower target load at steady state. As the actual stack outlet temperature decreases to the steady state temperature, the coolant flow rate will also decrease accordingly to that appropriate under steady state conditions at the lower load.

Similarly, on an up-transient, the load is increased to a higher target load, and the target coolant dT, target stack outlet temperature and target coolant flow rate at the higher target load are higher due to increased heat generation. Again, the actual coolant dT and actual stack outlet temperature do not increase immediately upon the load change due to the thermal mass of the stack, which results in a lower coolant flow rate than when the fuel cell is at steady state at the higher target load. Thus, the actual coolant dT and actual stack outlet temperature will increase faster (because the stack will heat up faster since the coolant flow rate is low) to the target coolant dT and target stack outlet temperature at steady state for the higher target load. As the actual stack outlet temperature increases to the steady state temperature, the coolant flow rate will also increase accordingly to that appropriate under steady state conditions at the high load.

Using this method, the coolant flow rate is varied based on the real-time conditions of the fuel cell stack, rather than immediately adjusted upon the load change. This eliminates the need of imposing a lag time when changing the operating conditions of the fuel cell stack, is simpler to implement than complex models, and does not require determination of the membrane resistance, which is often difficult and may require special equipment. Furthermore, the present method can take into consideration any fuel cell degradation that may affect the amount of heat that is generated during operation at various loads, which may be different for different fuel cell stack configurations. For example, the amount of heat generation at a particular load may change over the lifetime of the fuel cell stack and may be dependent on its operating history.

In some instances, the stack inlet temperature may be maintained within a predetermined temperature range for all loads by maintaining a constant coolant inlet temperature. As mentioned before, the coolant is typically circulated from the outlet of the stack to the inlet of the stack. However, because the coolant outlet temperature is usually greater than the coolant inlet temperature, the coolant exiting the stack must be cooled before it is circulated back to the inlet. In one example, a portion of the coolant is partitioned from the outlet of the stack to a heat exchanger, such as a radiator, while a remainder portion is partitioned to the heat exchanger bypass. Thus, if a larger amount of the coolant is directed to the heat exchanger, the coolant temperature entering the stack will be lower. Conversely, if a larger amount of coolant flow is directed to the bypass, the coolant temperature entering the stack will be higher. A three-way variable valve may be employed in the coolant loop to control the amount of coolant flow between the heat exchanger and the heat exchanger bypass to maintain the stack inlet temperature within the predetermined range, if desired.

Alternatively, the stack inlet temperature may be varied. For example, at lower loads, it may be desirable to have a lower operating temperature from a durability standpoint because the rate of fuel cell degradation increases with increasing temperature. However, at higher loads, higher operating temperatures may be desirable to increase fuel efficiency. For example, fuel efficiency can be increased by reducing the load drawn by the radiator, which results in a higher coolant inlet temperature, and thus a higher fuel cell operating temperature. In one example, the stack inlet temperature may be varied based on the detected stack outlet temperature. Alternatively, the stack inlet temperature may be varied based on the load requested during the load transient.

In another embodiment, the oxidant stoichiometry is adjusted based on the detected stack outlet temperature, for example, by varying the oxidant flow rate, to reduce excessive drying or flooding during load transients. For instance, the oxidant stoichiometry is varied inversely with the detected stack outlet temperature.

The reactant stoichiometry is defined as the ratio between the amount of reactant supplied to the fuel cell stack to the amount of reactant consumed by the fuel cell stack. The amount of reactant supplied to the fuel cell stack may be expressed in terms of a molar flow rate or mass flow rate. To prevent reactant starvation, the minimum required reactant stoichiometry is 1.0 (i.e., the amount of reactant supplied is the same as the amount of reactant consumed). One of ordinary skill in the art will appreciate that when operating a fuel cell stack at a constant reactant stoichiometry of 1.0, the reactant flow rate will be lowest at low loads and highest at high loads. Typically, the reactant stoichiometry is greater than 1.0, for instance, equal to or greater than 1.4 for the oxidant stoichiometry because the cathode half-cell reaction is slow.

As described in the foregoing, at steady state conditions at a high load, the target coolant dT, target stack outlet temperature and target coolant flow rate are typically higher. At the same time, the target oxidant stoichiometry is preferably lower to reduce the power consumed by the air compressor and to prevent over-drying at the outlet region of the fuel cells (because the stack outlet temperature is high). On a down-transient, the actual stack outlet temperature immediately upon the load decrease is usually higher than the target stack outlet temperature at steady state at a particular load. Since the oxidant stoichiometry varies with the actual stack outlet temperature, the oxidant stoichiometry will also initially remain low so that the stack outlet does not become too dry, due to the lower amount of water generation at low load and the high stack outlet temperature. As the stack outlet temperature decreases, the oxidant stoichiometry will increase accordingly.

Conversely, at steady state conditions at a low load, the target coolant dT, target stack outlet temperature and target coolant flow rate are typically lower, while the target oxidant stoichiometry is typically higher to promote water removal from the fuel cells (because the stack outlet temperature is low). On an up-transient, the actual stack outlet temperature will initially remain lower than that desired at the target load, while the oxidant stoichiometry will remain high to remove any water in liquid and/or vapour form from the fuel cell stack. As the stack outlet temperature increases, the oxidant stoichiometry will decrease accordingly.

In the embodiments described above, the actual stack outlet temperature may be determined by any method known in the art, for example, by using thermal sensors in the coolant, oxidant, and/or fuel streams, and/or in the flow field plates, at the outlet of the stack. The stack outlet temperature may be determined continuously or intermittently (for example, once per second or 10 times per second).

In the present invention, the coolant flow rate, oxidant stoichiometry and/or stack inlet temperature is determined based solely on the actual stack outlet temperature. As used herein, the word “solely” means that other parameters need not be considered since the actual stack outlet temperature is sufficient to provide the information necessary to calculate the coolant flow rate and/or oxidant stoichiometry and/or stack inlet temperature to more quickly reach steady state conditions for a fuel cell undergoing a load transient. In some instances, the target coolant flow rate, target oxidant stoichiometry and/or target stack inlet temperature may be determined as a mathematical equation or function of the actual stack outlet temperature. Alternatively, the target coolant flow rate, target oxidant stoichiometry and/or target stack inlet temperature may be determined in the form of a look-up table based on the actual stack outlet temperature.

The present invention may be implemented by a controller in the fuel cell system communicatively coupled to receive signals from various sensors (e.g., stack outlet temperature, coolant flow rate, reactant stoichiometries), and/or to control the states of the reactants (e.g., pressure, stoichiometries, temperature), and the various pumps, compressors, and the like in the fuel cell system. In one embodiment, the controller may receive signals indicative of the actual stack outlet temperature and the actual coolant flow rate. The controller then determines the target coolant flow rate based on the actual stack outlet temperature. If the actual coolant flow rate is different from the determined target coolant flow rate, the controller sends command signals that cause the coolant flow rate to converge to the determined target coolant flow rate. For example, the coolant pump or other similar device may be operated to adjust the coolant flow rate to achieve the determined target coolant flow rate. Similarly, the controller may receive signals indicative of the actual oxidant stoichiometry and determines the target oxidant stoichiometry based on the actual stack outlet temperature. If the actual oxidant stoichiometry is different from the determined target oxidant stoichiometry, the controller sends command signals that cause the oxidant stoichiometry to converge to the determined target oxidant stoichiometry. For example, the oxidant compressor, blower or other similar device may be operated to adjust the oxidant stoichiometry to achieve the determined target oxidant stoichiometry.

The controller may take a variety of forms such as microprocessors, microcontrollers, application-specific integrated circuits (ASIC), and/or digital signal processors (DSP), with or without associated memory structures such as read only memory (ROM) and/or random access memory (RAM). In some embodiments, the controller may be configured to store a mathematical equation or function to determine the coolant flow rate (as well as the oxidant stoichiometry and/or stack inlet temperature), based on the actual stack outlet temperature. Alternatively, the controller may be configured to store a plurality of stack outlet temperatures and coolant flow rates (as well as the determined oxidant stoichiometries and/or stack inlet temperatures) in the form of a look-up table, for example.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

1. A method of operating a fuel cell stack having at least one fuel cell during a load transient, the method comprising:
providing fuel and oxidant to the fuel cell stack at a fuel stoichiometry and an oxidant stoichiometry, respectively;
circulating a coolant through the fuel cell stack at a coolant inlet temperature and a coolant flow rate;
determining a stack outlet temperature;
determining a target coolant flow rate based solely on the determined stack outlet temperature; and
adjusting the coolant flow rate based on the determined target coolant flow rate.

2. The method of claim 1, wherein the stack outlet temperature is determined by determining at least one of a coolant outlet temperature, a fuel outlet temperature, and an oxidant outlet temperature.

3. The method of claim 1, wherein the determined stack outlet temperature is between 50° C. and 12° C.

4. The method of claim 1, wherein the target coolant flow rate increases as the determined stack outlet temperature increases.

5. The method of claim 1, further comprising
determining an oxidant stoichiometry based on the determined stack outlet temperature; and
adjusting the oxidant stoichiometry based on the determined oxidant stoichiometry.

6. The method of claim 1, further comprising providing at least one of the fuel and the oxidant at a relative humidity of less than 100%.

7. The method of claim 1, further comprising maintaining a coolant inlet temperature within a predetermined range.

8. The method of claim 1, further comprising varying a coolant inlet temperature based on the determined stack outlet temperature.

9. A method of operating a fuel cell stack having at least one fuel cell during a load transient, the method comprising:
providing fuel and oxidant to the fuel cell stack at a fuel stoichiometry and an oxidant stoichiometry, respectively;
circulating a coolant through the fuel cell stack at a coolant flow rate;
determining a stack outlet temperature;
determining a target oxidant stoichiometry based solely on the determined stack outlet temperature; and
adjusting the oxidant stoichiometry based on the determined target oxidant stiochiometry.

10. The method of claim 9, wherein the stack outlet temperature is determined by determining a coolant outlet temperature.

11. The method of claim 9, wherein the determined stack outlet temperature is between 50° C. and 12° C.

12. The method of claim 9, wherein the determined target oxidant stoichiometry is between 1.0 and 3.0.

13. The method of claim 9, wherein the determined target oxidant stoichiometry increases as the determined stack outlet temperature decreases.

14. The method of claim 9, further comprising providing at least one of the fuel and the oxidant at a relative humidity of less than 100%.

15. A fuel cell system comprising a fuel cell stack and a control device, wherein the control device is configured to:
receive signals indicative of a stack outlet temperature;
receive signals indicative of a coolant flow rate;
determine a target coolant flow rate based solely on the stack outlet temperature; and
send command signals that cause the coolant flow rate to converge to the determined target coolant flow rate when the coolant flow rate is different from the determined target coolant flow rate.

16. The fuel cell system of claim 15, wherein the control device is configured to determine the target coolant flow rate based on the determined stack outlet temperature by means of a mathematical equation or look-up table.

17. A fuel cell system comprising a fuel cell stack and a control device, wherein the control device is configured to:
receive signals indicative of a stack outlet temperature;
receive signals indicative of an oxidant stoichiometry;
determine a target oxidant stoichiometry based solely on the stack outlet temperature;
send command signals that cause the oxidant stoichiometry to converge to the determined target oxidant stoichiometry when the oxidant stoichiometry is different from the determined target oxidant stoichiometry.

18. The fuel cell system of claim 17, wherein the control device is configured to determine the target oxidant stoichiometry based on the stack outlet temperature by means of a mathematical equation or look-up table.
